(19) United States
(12) Patent Application Publication
(10) Pub. No.: US 2018/0143853 A1
(43) Pub. Date: May 24, 2018

(54) Circuits and Methods Providing Core Scheduling in Response to Aging for a Multi-Core Processor

(71) Applicant: QUALCOMM INCORPORATED, San Diego, CA (US)

(72) Inventors: Mehdi Saeidi, San Diego, CA (US); Niladri Mojumder, San Diego, CA (US); Min Chen, San Marcos, CA (US); Rajat Mittal, San Francisco, CA (US); Rajit Chandra, Cupertino, CA (US)

(21) Appl. No.: 15/398,864

(22) Filed: Jan. 5, 2017

Related U.S. Application Data
(60) Provisional application No. 62/423,883, filed on Nov. 18, 2016.

(51) Int. Cl. G06F 9/48; G06F 9/445

(52) U.S. Cl. CPC G06F 9/4881; G06F 9/44505

(57) ABSTRACT

A system includes a computer processor including N cores; and a plurality of device aging sensors, wherein each one of the plurality of device aging sensors is disposed within a respective core, the plurality of device aging sensors being configured to communicate core aging information with a core scheduler in the computer processor, wherein the core scheduler is configured to make a first set of M cores available to a thread scheduler and remaining cores of the N cores unavailable to the thread scheduler in a first time period in which the core aging information indicates that aging of the first set of M cores is below a threshold, and wherein the core scheduler is configured to make a second set of M cores available to the thread scheduler and remaining cores of the N cores unavailable to the thread scheduler in a second time period.

### CROSS-REFERENCE TO RELATED APPLICATIONS

The present application claims the benefit of U.S. Provisional Patent Application No. 62/423,883, filed Nov. 18, 2016, and entitled “Circuits and Methods Providing Core Scheduling in Response to Aging for a Multi-Core Processor”, the disclosure of which is incorporated by reference herein in its entirety.

### TECHNICAL FIELD

The present application relates, generally, to scheduling cores of a multi-core processor and, more specifically, to scheduling cores based at least in part on aging properties of cores.

### BACKGROUND

A central processing unit (CPU) may include a plurality of cores. For instance, one current design uses eight CPU cores. However, many processing tasks may be accomplished using only one or two of the CPU cores. For instance, it has been observed that for one example 8-core CPU, only one or two cores are active 99% of the time. It has also been observed that transistors age over time, and an aged transistor may use a slightly higher voltage to accomplish the same performance as it would have when new.

The CPU has a thread scheduler, which is a software function that assigns processing threads to specific cores. The thread scheduler is programmed to have one or two cores as a default. In this way, the thread scheduler tends to assign threads to the same one or two cores in almost all instances. Of course, the thread scheduler may use a variety of criteria to assign threads to specific cores, but the use of one or two cores as a default causes the CPU to rely on the same one or two cores mostly to the exclusion of the other cores.

Such default reliance on one or two cores may result in accelerated aging of the transistors in those one or two cores. One conventional system supplies extra voltage to the cores to compensate for transistor aging, but such conventional approach may adversely affect battery life. Accordingly, there is a need in the art for a system to efficiently schedule cores and increase battery life.

### SUMMARY

Various embodiments are directed to circuits and methods that schedule cores at least in part based on aging information from those cores. In one example, a new system on chip (SOC) has eight cores total, and two of those cores are set as available cores. Moreover, the core scheduler makes the remaining six cores unavailable for use by a thread scheduler. As the two cores operate over a period of time, their respective aging sensors report aging data back to the core scheduler. In response to aging data, the core scheduler then makes a next set of two cores available and makes the remaining six cores unavailable. The core scheduler repeats this process, and after all eight cores have been used, the system may then start again with the first set of two cores and apply a voltage guard band to compensate for core aging.

According to one embodiment, a system includes a computer processor including N cores, wherein N is an integer greater than two; and a plurality of device aging sensors, wherein each one of the plurality of device aging sensors is disposed within a respective core, the plurality of device aging sensors being configured to communicate core aging information with a core scheduler in the computer processor, wherein the core scheduler is configured to make a first set of M cores available to a thread scheduler and remaining cores of the N cores unavailable to the thread scheduler in a first time period in which the core aging information indicates that aging of the first set of M cores is below a threshold, and wherein the core scheduler is configured to make a second set of M cores available to the thread scheduler and remaining cores of the N cores unavailable to the thread scheduler in a second time period in response to the core aging information.

According to another embodiment, a system includes: computer processor means for executing computer-readable instructions, the computer processor means including N cores, wherein N is an integer greater than two; means for measuring aging of transistors within each of the N cores and for providing core aging information to the computer processor means; means for scheduling processing threads to ones of the cores; and means for scheduling the cores, wherein the core scheduling means is configured to make a first set of M cores out of the N cores visible to the processing thread scheduling means and remaining cores of the N cores unavailable to the processing thread scheduling means during a first time period during which the core aging information indicates that aging of the first set of M cores is below a threshold, and wherein the core scheduling means is further configured make a second set of M cores out of the N cores available to the processing thread scheduling means and the first set of M cores unavailable to the processing thread scheduling means during a second time period in response to the core aging information indicating that aging of the first set of M cores is at or above the threshold.

According to another embodiment, a non-transitory computer readable medium having computer-readable instructions stored thereon, wherein the computer-readable instructions when executed by a multi-core computer processor having N cores cause the multi-core computer processor to: populate a data structure of available cores with identifications of a first set of M cores out of the N cores and omitting from the data structure cores not included in the first set of M cores; access the data structure to schedule threads to cores of the first set of M cores; receive core aging information from a first set of device aging sensors associated with cores of the first set of M cores; in response to receiving the core aging information from the first set of device aging sensors, repopulate the data structure of available cores with identifications of a second set of M cores out of the N cores and omitting from the data structure cores not included in the second set of M cores, wherein the first and second sets are different; and after repopulating the data structure, access the data structure to schedule threads to cores of the second set of M cores.

### BRIEF DESCRIPTION OF THE DRAWINGS

FIG. 1 is an illustration of an example computing device that may perform a method according to various embodiments.

FIG. 2 is an illustration of an example internal architecture of the computing device of FIG. 1, according to one embodiment.

FIG. 3 is an illustration of an example SOC that may be included in the computing device of FIG. 1, and may itself include processing units to schedule cores and assign threads, according to one embodiment.

FIGS. 4A-4E are illustrations of an example table to indicate available cores, according to one embodiment.

FIG. 5 is an illustration of a flow diagram of an example method of scheduling cores, according to one embodiment.

FIG. 6 is an illustration of a flow diagram of an example method of scheduling cores and assigning threads, according to one embodiment.

### DETAILED DESCRIPTION

Various embodiments provided herein include systems and methods to schedule cores at least in part in response to aging information. Such embodiments may rotate through sets of cores, iteratively selecting a next set of new cores before returning to a first set of aged cores.

An example embodiment includes a set of available cores, out of a total number of cores. For example, when the CPU is new, a first set of cores may be designated as the available cores by a core scheduler. Therefore, when the CPU boots up the CPU will use the first set of cores to perform most or all of the boot up activities and also assign threads during normal operation to the first set of cores. However, in this example cores that are not in the first set of cores are not used because they are not available to the thread scheduler.

Continuing with this example, each of the cores the CPU includes at least one aging sensor to measure aging. An example of an aging sensor may include a ring oscillator and a counter, where it is assumed that transistors in the ring oscillator will age similarly to transistors in the processing portion of the given core. A decreased number of oscillations in a given time and at a given voltage may indicate aging of the transistors in a core. From time to time, the core scheduler may analyze data from the aging sensors and determine that aging has caused a performance of the cores of the first set of cores to dip below a particular threshold. For instance, for a same voltage level, a reduction of 10% or so in oscillations of the ring oscillator may trigger an aging flag to be set.

In response to this information from the aging sensor, the core scheduler designates a second set of cores as the available cores. In one example, designating the second set of cores as the available cores may include writing data to an address of nonvolatile memory to indicate an identification of one or more cores as available cores. Furthermore this example, the cores that are not indicated as available cores are not included in the data that is written to the address of nonvolatile memory. The CPU thread scheduler accesses that address of nonvolatile memory to determine the available cores and then assigns threads to those cores during normal operation and at boot up. An example may include a table or other data structure that includes identifications of available cores and omits identifications of cores other than the available cores.

The result is that the core scheduler may change an available core setting based on information from an aging sensor. One example includes a multi-core CPU having eight cores. When the CPU is new, cores 0 and 1 are designated as the available cores. After a while, e.g., a year or so, the aging sensor detects aging of the transistors of cores 0 and 1. In response, the core scheduler designates cores 2 and 3 as the available cores. As time goes by, the transistors of cores 2 and 3 may age as well until their aging sensors indicate performance has crossed a threshold, and in response the core scheduler now designates cores 4 and 5 as the available cores. Similarly, once aging information indicates that performance of cores 4 and 5 has crossed a threshold, the core scheduler the designates cores 6 and 7 as the available cores. Thus, the core scheduler has rotated through four sets of two cores each, so that each one of the eight cores has been included in a set of available cores.

Continuing with this example, the core scheduler may determine that the performance of cores 6 and 7 has crossed that threshold. The core scheduler may then designates cores 0 and 1 as the available cores once again. However, since cores 0 and 1 have substantial aging, processes within the CPU then apply a supply voltage guard band to cores 0 and 1 during normal operation to compensate for the aging. For instance, the supply voltage guard band may include an incremental amount of voltage above a nominal operating voltage, which makes the transistors of cores 0 and 1 operate incrementally faster so that performance is comparable to the performance expected of cores 0 and 1 when they were new. Of course, cores 0 and 1 may consume more power than when new. Of note in this example is that cores 0-7 when they were new were operated without a supply voltage guard band, and the supply voltage guard band is first applied when cores 0 and 1 have been aged and are rotated back in as the available cores. Accordingly, the CPU avoids applying age-compensating supply voltage guard band for a relatively long time by rotating in new cores if new cores are available.

Various embodiments may be performed by hardware and/or software in a computing device. For instance, some embodiments include hardware and/or software algorithms performed by a processor, which can be part of an SOC, in a computing device as the device operates. Various embodiments may further include nonvolatile or volatile memory set aside in an integrated circuit chip in a computing device to store the data structure indicating available cores and a memory address storing the threshold.

An advantage of some embodiments described above is that they may experience increased days of use for a given battery charge compared to a conventional solution that does not rotate in new cores and simply increases operating voltage in response to aging. Embodiments may be implemented in any computing device with multiple cores where aging is a concern, and specifically in CPUs for wireless communication devices, where battery life is a limiting factor.

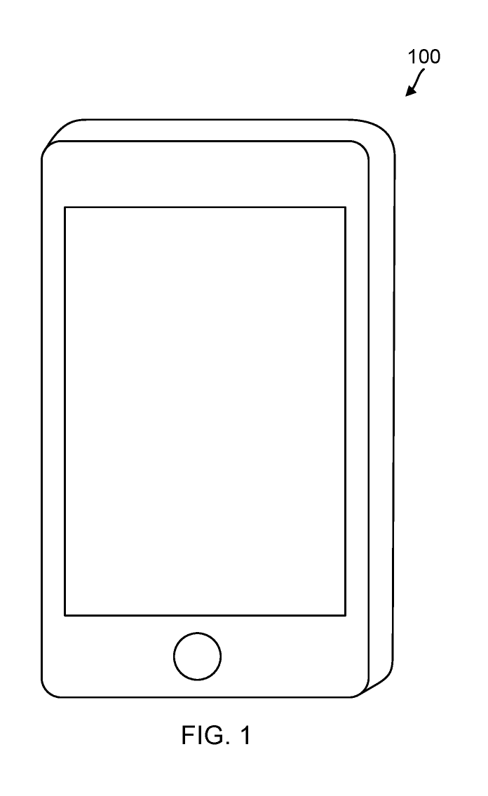

FIG. 1 is a simplified diagram illustrating an example computing device 100 in which various embodiments may be implemented. In the example of FIG. 1, computing device 100 is shown as a smart phone. However, the scope of embodiments is not limited to a smart phone, as other embodiments may include a tablet computer, a laptop computer, or other appropriate device. In fact, the scope of embodiments includes any particular computing device, whether mobile or not. Embodiments including battery-powered devices, such as tablet computers and smart phones, may benefit from the concepts disclosed herein. Specifically, the concepts described herein provide techniques to conserve battery life and improve processing speed by using new cores when those new cores are available.

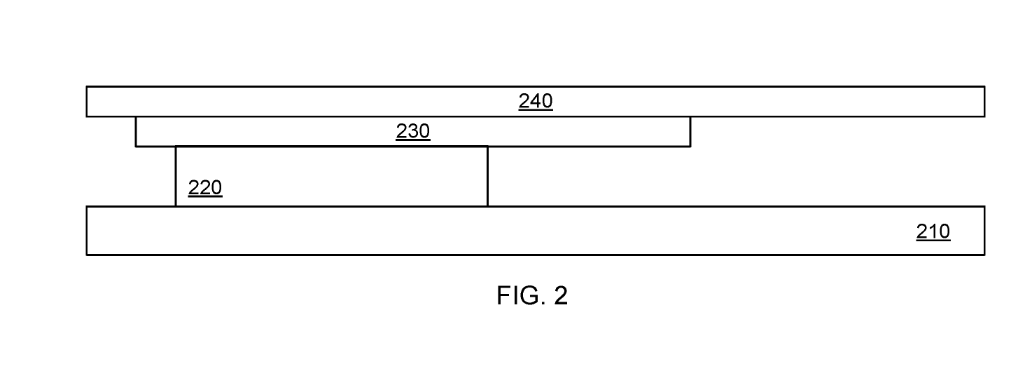

FIG. 2 illustrates an example arrangement of some external and internal components of computing device 100, according to one embodiment. In this example, the processing components of the computing device are implemented as a system on chip (SOC) within a package 220, and the package 220 is mounted to a printed circuit board 210 and disposed within the physical housing of computing device 100. A heat spreader and electromagnetic interference (EMI) layer 230 is disposed on top of SOC package 220, and the back cover 240 is disposed over the layer 230. The package 220 including the processor can be mounted in a plane parallel to a plane of the display surface and a plane of the back cover 240.

Although not shown in FIG. 2, it is understood that computing device 100 may include other components, such as a battery, other printed circuit boards, other integrated circuit chips and the chip packages, and the like. The battery, the printed circuit boards, and the integrated circuit chips are disposed within the computing device 100 so that they are enclosed within the physical housing of the computing device 100.

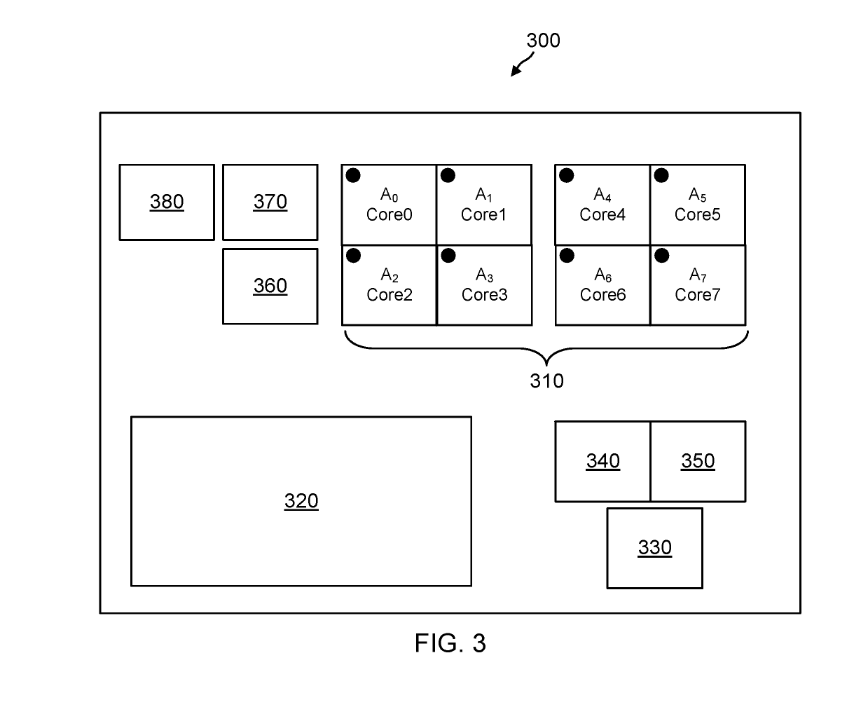

FIG. 3 is an illustration of example SOC 300, which may be included within package 220 of the embodiment of FIG. 2, according to one embodiment. In this example, SOC 300 is implemented on a semiconductor die, and it includes multiple system components 310-380. Specifically, in this example, SOC 300 includes CPU 310 that is a multi-core general purpose processor having the eight processor cores, core 0-core 7. Of course, the scope of embodiments is not limited to any particular number of cores, as other embodiments may include two cores, four cores, or any other appropriate number of cores in the CPU 310. SOC 300 further includes other system components, such as a first digital signal processor (DSP) 340, a second DSP 350, a modem 330, graphics processing unit (GPU) 320, a video subsystem 360, a wireless local area network (WLAN) transceiver 370, and a video-front-end (VFE) subsystem 380.

Further in this example, CPU 310 executes computer readable code to provide the functionality of a core scheduler and a thread scheduler. For instance, in this example the core scheduler and thread scheduler include firmware that is executed by one or more of the cores of CPU 310 as part of an operating system kernel. Of course, various embodiments may implement a core scheduler or thread scheduler in other appropriate ways, such as part of a higher-level component of an operating system stack. The core scheduler designates ones of the cores as the available cores, and the thread scheduler assigns threads to those available cores during operation of the CPU 310.

Continuing with the example of FIG. 3, CPU 310 includes aging sensors associated with each of the cores 0-7. In this example, each one of the cores 0-7 includes a corresponding aging sensor, A₀-A₇. However, the scope of embodiments is not limited to having a single aging sensor at each core, as other embodiments may include any appropriate number of aging sensors to detect aging of transistors within the CPU cores.

As noted above, an aging sensor in one example may be implemented using a ring oscillator and a counter. Such a system assumes that the transistors of the ring oscillator age at a same or similar rate as transistors in a corresponding core, so such system may implement the ring oscillator using similar transistors as those used in processing portions of the cores and physically placed close to the processing portions of the cores. Furthermore, a given ring oscillator may be powered using a same power rail as transistors of processing portions of its corresponding CPU core, so that the ring oscillator experiences similar voltage and temperature as the core it monitors.

When a given core has experienced relatively little lifetime use, the ring oscillator may indicate a higher number of oscillations during a given time for a given operating voltage. However, as a core is used over its lifetime, its transistors experience some amount of age. Substantial age may be indicated by a smaller number of oscillations during a given time for a given operating voltage. The CPU core scheduler may receive core aging information by, e.g., polling a counter associated with a ring oscillator of the core. The CPU core scheduler may track the core aging information over time and compare it to a threshold. Such threshold may be set at any appropriate level and may, e.g., correspond to a number of oscillations read from a counter of an aging sensor.

Over time as the aging of the transistors causes fewer oscillations during a given time to be saved in an aging sensor's counter, the CPU scheduler compares the aging data to the threshold, and if the aging data indicates that aging has exceeded the threshold, the CPU scheduler may set an aging flag. One example of determining that aging has exceeded the threshold includes determining that a number of bits output by the counter during a period of time is below a designated number. However, the scope of embodiments is not limited to any particular threshold, nor any particular technique to compare aging data to the threshold.

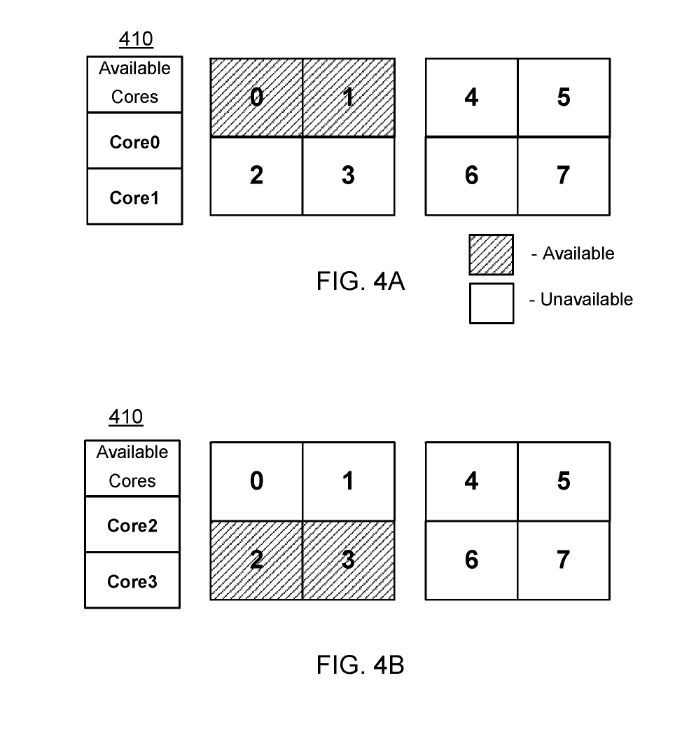

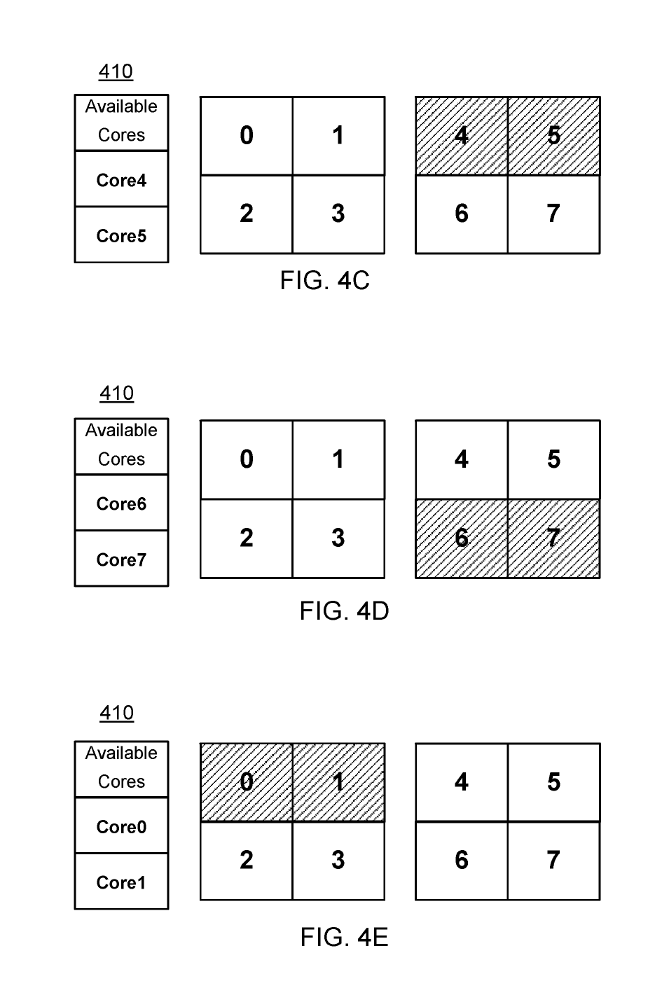

The core scheduler takes into account aging data as it designates sets of the cores as available. FIGS. 4A-4 E illustrates an example process of rotating through sets of cores, according to one embodiment. Beginning at FIG. 4A, when the CPU 310 itself is new, the core scheduler designates cores 0 and 1 as the available cores. For example, the core scheduler may employ a data structure such as table 410 to identify the available cores. In the example of FIG. 4A, core 0 and core 1 are designated as the available cores. Table 410 also omits identifying cores 2-7, which are unavailable. Accordingly, cores 0 and 1 are visible to the thread scheduler, whereas cores 2-7 are invisible to the thread scheduler.

During operation of the computing device 100 (FIG. 1), the user may interact with the computing device 100 to open or close one or more applications, to consume content such as video or audio streams, or other operations. In one example in which a user opens an application, such application may be associated with tens or hundreds of processing threads that would then be placed in various queues of the processing components 310, 320, 340, 350. Each of the cores core 0-core 7 includes its own processing queue as well. The thread scheduler is responsible for placing the processing threads in the various queues according to a variety of different criteria. One particular criterion may include capability of a core or processing unit. Another criterion includes temperature of a particular core or processing unit, where a core or processing unit having a lower temperature may be preferred over another core or processing unit having a higher temperature. However, in this example, the thread scheduler accesses the table 410 to identify the available cores. Having identified only cores 0 and 1 as available, the thread scheduler may only use cores 0 and 1, though the thread scheduler may select core 0 or core 1 for a particular thread based on any appropriate criteria. The system may also assign some threads to other processing units, such as GPU 320, as appropriate.

In various embodiments, the core scheduler operating on CPU 310 stores Table 410 in nonvolatile memory that is available to a kernel or other operating system functionality. The thread scheduler is programmed to access an address in the nonvolatile memory that corresponds to table 410. For example, the thread scheduler may access the table 410 each time it receives a new thread to be assigned, during a thread rebalancing operation at periodic intervals, or at other times.

As time progresses, the core scheduler may track core aging data and determine that cores 0 and 1 have aged beyond a threshold. The core scheduler may then designate a next set of cores as available. In the example of FIG. 4B, the core scheduler has designated cores 2 and 3 as the next set of available cores and has updated table 410 accordingly. The thread scheduler then assigns threads to cores 2 and 3 during operation. Of note is that FIGS. 4A and 4B represent operation of the core scheduler during different time periods, where those time periods are determined at least in part by the core scheduler's analysis of aging data. Similarly, each of FIGS. 4A-4E represent operation of the core scheduler during different time periods.

FIG. 4C illustrates that cores 2 and 3 may have aged, so that the core scheduler may then designate cores 4 and 5 as the available cores. The core scheduler updates table 410 to identify cores 4 and 5 as available cores and omits cores 0-3 and 6-7. The thread scheduler assigns threads to cores 4 and 5.

Moving to FIG. 4D, after the core scheduler determines that cores 4 and 5 have aged beyond the threshold, the core scheduler may then designate cores 6 and 7 as the available cores by updating table 410. Table 410 identifies cores 6 and 7 and omits cores 0-5. The thread scheduler assigns threads to cores 6 and 7.

In the examples of FIGS. 4A-4D, the core scheduler rotates in a new set of cores each time a current set of cores reaches an aging threshold. During operation of CPU 310, other processes are at work, such as a power reduction process that adjusts a supply voltage to the cores in response to a number of factors. Such factors may include, e.g., temperature and process variation. In the present example, the power reduction process may also adjust a supply voltage to the cores in response to the core aging data as well. For instance, as a core ages, the power reduction process may incrementally apply a higher voltage above a nominal voltage to compensate for aging-related performance degradation of the transistors. Such age-compensating incremental voltage increase is referred to in this example as a voltage guard band.

Various embodiments described herein may eliminate or reduce use of the voltage guard band by switching out an aging set of cores for a new set of cores when the core scheduler sets an aging flag. Thus in one example, the core scheduler may be programmed to switch from one set of available cores to another set of available cores before the power reduction process would have otherwise begun applying a voltage guard band. In the example of FIGS. 4A-4D, the core scheduler could then cycle through each of the cores 0-7 once before the power reduction process may intervene to apply voltage guard band.

Of course, the scope of embodiments is not limited to systems that eliminate use of a voltage guard band. For instance, other embodiments may allow use of cores past the point of aging where a voltage guard band would be applied, switching from one set of cores to another set of cores in response to a higher aging threshold.

Nevertheless, once each of the cores 0-7 have been cycled through, the core scheduler may have no new cores remaining. Such scenario is illustrated in FIG. 4E, wherein the core scheduler has returned to indicating that cores 0 and 1 are available and cores 2-7 are unavailable. The thread scheduler then assigns the threads to cores 0 and 1, according to the information in table 410. Further in this example, since cores 0 and 1 have aged, the scenario shown in FIG. 4E may be accompanied by application of a voltage guard band to compensate for the aging of the cores. Although not shown in FIGS. 4A-4E, the core scheduler may continue to cycle through sets of cores, perhaps by setting an incrementally higher aging threshold each time each of the cores have been cycled through once.

During use, in one example, the aging threshold may be set so that expected use by a consumer would result in the set of available cores being switched every six months to one year. In such a scenario, with eight cores available, a user would use the electronic device for between two and four years before each of the eight cores would have been cycled through. In many instances, a consumer will have replaced the device by that time, and the consumer may never experience slow performance or increased power usage due to core aging. The aging threshold may be set according to any suitable criteria, including an expected time of use of the consumer. Furthermore, the aging threshold may be set during manufacture or at other appropriate time and may be saved to nonvolatile memory to be accessed by the core scheduler from time to time.

Various embodiments may include one or more advantages over conventional systems. For instance, various conventional systems may continue to use aging cores even when new cores are available in a multi-core CPU. Such conventional systems may then apply voltage guard band to compensate for aging at the expense of loss of battery life.

By contrast, various embodiments described herein rotate through the cores from one set of the cores to the next set of the cores based at least in part on aging information of the cores. Such embodiments may conserve battery life by reducing or eliminating use of a voltage guard band. Furthermore, such embodiments may spread the wear of aging among a total number of cores substantially equally, thereby reducing the possibility that any one core suffers from aging disproportionately and thus disproportionately reduces battery life. Of course, battery life is only one metric that may benefit from various embodiments. For instance, the embodiments described herein may also result in faster operation, as perceived by a consumer, due to the use of fresh cores from time to time.

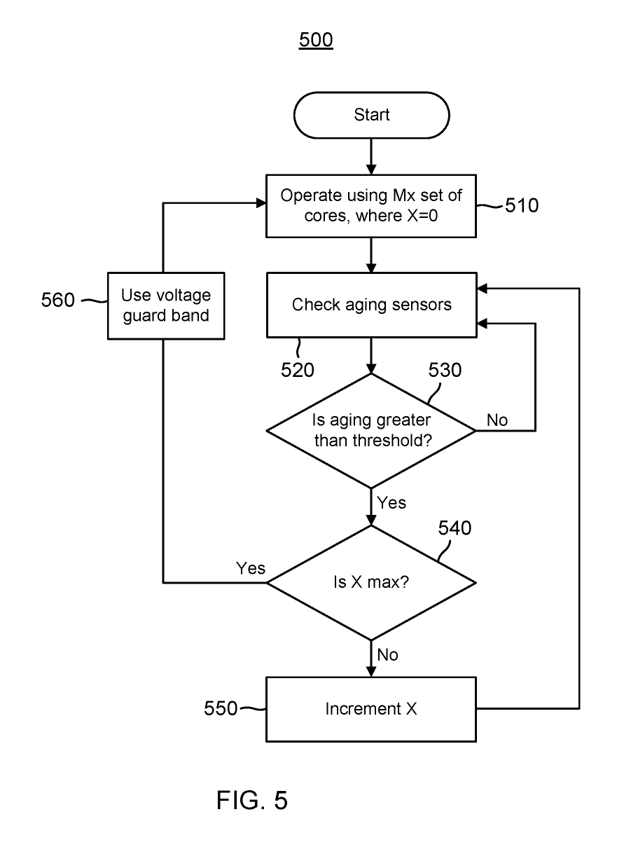

A flow diagram of an example method 500 for scheduling the cores of a multi-core processing unit is illustrated in FIG. 5. In one example, method 500 is performed by a computer processor having a core scheduler, which may include hardware and/or software functionality at a processor of the computing device. In some examples, a core scheduler includes processing circuitry that executes computer readable instructions to receive and analyze core aging data and to designate some cores as available in other cores as unavailable in response to the core aging data. A processing thread scheduler then accesses information indicating the available cores and assigns processing to appropriate queues of the available cores according to various criteria. As mentioned above, in one example, a core scheduler and thread scheduler may include functionality at an operating system kernel, although the scope of embodiments is not so limited.

The embodiment of FIG. 5 includes performing actions 510-560 during operation of a chip, such as SOC 300 (FIG. 3). Further, the embodiment of FIG. 5 includes performing the actions of method 500 over a period of months or years. For instance, a computer processor may perform actions 520 and 530 multiple times per second during operation, but may determine that an aging sensor indicates aging has met or exceeded the threshold only after a relatively long time span, such as a span of months. Accordingly, in some embodiments, some of the actions of method 500 may not be performed during one instance of power-up to power-down use by a consumer.

At action 510, the core scheduler has indicated that a first set of M cores out of a total number N of cores is available. This first set is the initial set, so that is designated M_{X}, where X is zero. An example is shown in FIG. 4A, where the first set of M cores includes a set of two cores—cores 0 and 1. The total number N is eight.

At action 520, the core scheduler checks aging sensors. In one example, the core scheduler may poll the different aging sensors to retrieve a number of bits stored in counters associated with the aging sensors. A fewer number of bits in a given time interval may indicate an increase in aging-related degradation. The core scheduler may check the aging sensors of only the cores in the first subset of M₀, though the scope of embodiments may include checking aging sensors of other ones of the cores as well.

At action 530, the core scheduler determines whether aging is greater than a threshold. As noted above, the aging threshold may be correlated with a number of bits read from a ring oscillator aging sensor during a pre-programmed amount of time. However the scope of embodiments may include determining whether aging has met or exceeded the threshold in any appropriate manner Action 530 may include comparing the aging data to the threshold to determine whether aging has met or exceeded the threshold. If it is determined at action 530 that aging has not met or exceeded the threshold, method 500 returns to action 520 where it continues to check the aging sensors during operation.

However, if it is determined at action 530 that aging has met or exceeded the threshold, then the core scheduler moves to action 540. At action 540, the core scheduler prepares to switch from one set of active cores to another set of active cores. Specifically, in this example, action 540 includes determining whether there is at least one set of new cores left or whether all the cores have been cycled through. If there is still at least one set of new cores left, X is not at its maximum, and the core scheduler increments X by designating the next set of cores as available and making the remaining cores unavailable. An example is shown at the transition between FIGS. 4A and 4B, wherein the core scheduler switches from cores 0 and 1 to cores 2 and 3 subsequent to determining that either or both of cores 0 and 1 have met or exceeded the aging threshold. Action 550 may include updating a table to identify the available cores while indicating the remaining cores are unavailable, e.g., by omitting the unavailable cores from the table altogether.

With each set of cores, the thread scheduler continues to access the data that indicates the available cores and then to assign processing threads to queues of those available cores during use of the device. The method returns to action 520, where the core scheduler checks aging sensors.

At action 540, if X is at a max, then each of the cores has been cycled through at least once, and the method 500 is at the last set of cores. In this example, the core scheduler resets X to zero. An example is shown at the transition between FIGS. 4D and 4E, where the core scheduler goes back to designating cores 0 and 1 as the available cores. The system may then apply a voltage guard band (action 560) if appropriate to compensate for aging of the sensors. The process may continue, wherein the core scheduler checks aging data and switches from one set of cores to the next set of cores throughout the lifetime of the device.

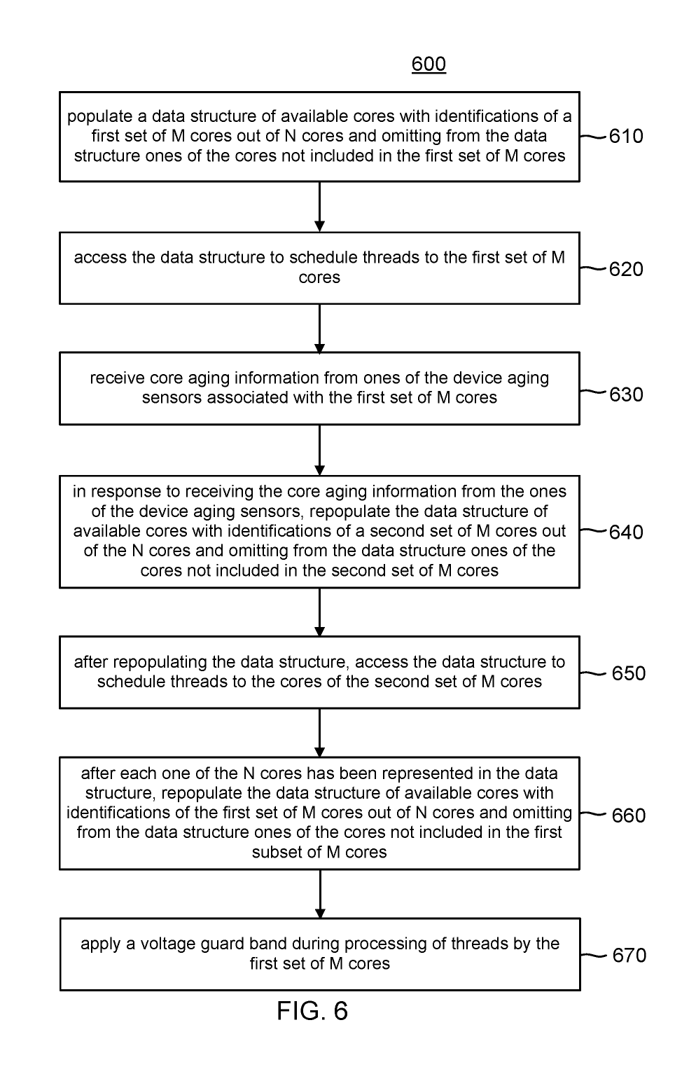

FIG. 6 is an illustration of example method 600, adapted according to one embodiment. Method 600 illuminates various aspects of scheduling cores, and as such, complements the description above of FIG. 5. Method 600 may be performed by a computer processor having a core scheduling algorithm and a thread scheduling algorithm.

Action 610 includes populating a data structure of available cores with identifications of the first set of M cores out of N cores and omitting from the data structure cores that are not included in the first set of M cores. An example is shown at FIG. 4A, wherein the data structure includes a table 410 that identifies cores 0 and 1 as the available cores and omits cores 2-7 from the table 410.

Continuing with the example, N is an integer greater than two, and M is an integer smaller than N. In the examples above, N is eight and M is two, although the scope of embodiments is not limited to any particular value of N or M.

At action 620, a thread scheduler accesses the data structure to schedule threads to the cores in the set of M cores. Thus as new threads arrive or as load-balancing operations are performed, the thread scheduler assigns threads to queues of the available cores.

At action 630, the core scheduler receives core aging information from at least some of the device aging sensors that are associated with the cores in the first subset of M cores. Examples of aging sensors are illustrated above in FIG. 3 as A₀-A₇. The core scheduler may receive core aging information at periodic intervals or otherwise as appropriate.

At action 640, the core scheduler repopulates the data structure of available cores in response to receiving the core aging information. For instance, the core scheduler may determine that the aging information indicates that aging of the cores of the first set meets or exceeds an aging threshold. The core scheduler then designates the next set of M cores as available by repopulating the data structure (e.g., repopulating table 410) to identify the second subset of M cores and omitting other ones of the cores. An example is shown at the transition between FIGS. 4A and 4B, in which the core scheduler repopulates table 410 to indicate that cores 2 and 3 are available and the other cores 0-1 and 4-7 are unavailable by omission.

At action 650, the thread scheduling algorithm accesses the data structure to schedule threads to the cores of the second subset of M cores. Action 650 occurs subsequently to action 640. In this manner, the thread scheduling algorithm assigns threads to the available cores, and the unavailable cores are invisible to the thread scheduling algorithm by virtue of being omitted from the data structure.

At action 660, after each one of the cores has been represented in the data structure, the core scheduler repopulates the data structure of available cores with identifications of the first set of M cores and omits from the data structure ones of the cores that are not included in the first set of M cores. Action 660 may be performed in response to determining that the last remaining new set of cores has reached or exceeded that aging threshold. Thus, the core scheduler returns to the first set of M cores. Action 660 may be accompanied by action 670 to apply a voltage guard band during processing of threads by the first set of M cores. In other words, in this example, new cores are made available to avoid use of the voltage guard band, but when each of the N cores has aged past the threshold, the cycle repeats and adds a voltage guard band as appropriate. However, the scope of embodiments does not exclude applying a voltage guard band to compensate for aging before a particular set of cores is switched out to a new set of cores.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A system comprising:
a computer processor including N cores, wherein N is an integer greater than two; and
a plurality of device aging sensors, wherein each one of the plurality of device aging sensors is disposed within a respective core, the plurality of device aging sensors being configured to communicate core aging information with a core scheduler in the computer processor, wherein the core scheduler is configured to make a first set of M cores available to a thread scheduler and remaining cores of the N cores unavailable to the thread scheduler in a first time period in which the core aging information indicates that aging of the first set of M cores is below a threshold, and wherein the core scheduler is configured to make a second set of M cores available to the thread scheduler and remaining cores of the N cores unavailable to the thread scheduler in a second time period in response to the core aging information.

2. The system of claim 1, wherein the computer processor comprises a central processing unit (CPU) implemented within a system on chip (SOC).

3. The system of claim 1, wherein the computer processor is implemented within a system on chip (SOC) of a wireless communication device.

4. The system of claim 1, wherein each of the device aging sensors comprises a ring oscillator.

5. The system of claim 1, wherein the core scheduler is further configured to make the first set of M cores available to the thread scheduler and remaining cores of the N cores unavailable to the thread scheduler in a third time period subsequent to the second time period, and wherein the system applies a voltage guard band to the first set of M cores during the third time period, wherein the voltage guard band is configured to compensate for aging of the first set of M cores.

6. The system of claim 1, wherein the core scheduler comprises a process of an operating system kernel running on the computer processor.

7. A system comprising:
computer processor means for executing computer-readable instructions, the computer processor means including N cores, wherein N is an integer greater than two;
means for measuring aging of transistors within each of the N cores and for providing core aging information to the computer processor means;
means for scheduling processing threads to ones of the cores; and
means for scheduling the cores, wherein the core scheduling means is configured to make a first set of M cores out of the N cores visible to the processing thread scheduling means and remaining cores of the N cores unavailable to the processing thread scheduling means during a first time period during which the core aging information indicates that aging of the first set of M cores is below a threshold, and wherein the core scheduling means is further configured make a second set of M cores out of the N cores available to the processing thread scheduling means and the first set of M cores unavailable to the processing thread scheduling means during a second time period in response to the core aging information indicating that aging of the first set of M cores is at or above the threshold.

8. The system of claim 7, wherein the computer processor means comprises a central processing unit (CPU) implemented within a system on chip (SOC).

9. The system of claim 7, wherein the computer processor means is implemented within a system on chip (SOC) of a wireless communication device.

10. The system of claim 7, wherein each of the aging measuring means comprises a ring oscillator.

11. The system of claim 7, wherein the means for scheduling the cores identifies the first set of M cores during the first time period in a data structure that omits remaining cores of the N cores.

12. The system of claim 7, wherein the means for scheduling the cores is configured to rotate through the N cores and return to the first set of M cores after each of the N cores has been made available to the processing thread scheduling means; the system further including:
means for adjusting a supply voltage to the first set of M cores in response to the core aging information to compensate for aging of the first set of M cores.

13. The system of claim 12, wherein the supply voltage adjusting means is configured to apply a nominal voltage to the first set of M cores during the first time period.

14. The system of claim 7, wherein the processing thread scheduling means comprises a process included within an operating system kernel running on the computer processor means.

15. A non-transitory computer readable medium having computer-readable instructions stored thereon, wherein the computer-readable instructions when executed by a multi-core computer processor having N cores cause the multi-core computer processor to:
populate a data structure of available cores with identifications of a first set of M cores out of the N cores and omitting from the data structure cores not included in the first set of M cores;
access the data structure to schedule threads to cores of the first set of M cores;
receive core aging information from a first set of device aging sensors associated with cores of the first set of M cores;
in response to receiving the core aging information from the first set of device aging sensors, repopulate the data structure of available cores with identifications of a second set of M cores out of the N cores and omitting from the data structure cores not included in the second set of M cores, wherein the first and second sets are different; and
after repopulating the data structure, access the data structure to schedule threads to cores of the second set of M cores.

16. The non-transitory computer readable medium of claim 15, wherein the computer-readable instructions cause the multi-core computer processor to:
apply a nominal operating voltage to the first set of M cores during processing of threads by the first set of M cores.

17. The non-transitory computer readable medium of claim 15, wherein the computer-readable instructions cause the multi-core computer processor to:
after each one of the N cores has been represented in the data structure, repopulate the data structure of available cores with identifications of the first set of M cores and omitting from the data structure cores not included in the first set of M cores; and
apply the voltage guard band during processing of threads by the first set of M cores.

18. The non-transitory computer readable medium of claim 15, wherein a thread scheduler comprises a process of an operating system kernel running on the multi-core computer processor.

19. The non-transitory computer readable medium of claim 15, wherein the core aging information includes data from a plurality of ring oscillators located in the N cores.

20. The non-transitory computer readable medium of claim 15, wherein the data structure comprises a table stored to nonvolatile memory by the multi-core computer processor.
